(19) United States
(12) Patent Application Publication
(10) Pub. No.: US 2002/0138598 A1
(43) Pub. Date: Sep. 26, 2002

(54) System and method for automatically and dynamically modifying functions of mobile devices based on positional data

(75) Inventors: Steven A. Bade, Georgetown, TX (US); Mark-David J. McLaughlin, Austin, TX (US)

Correspondence Address: EDMOND A. DEFRANK, 20145 VIA MEDICI, NORTHRIDGE, CA, 91326, US

(73) Assignee: International Business Machines Corporation, Armonk, NY (US)

(21) Appl. No.: 09/815,547

(22) Filed: Mar. 22, 2001

(51) Int. Cl. G06F 15/177

(52) U.S. Cl. 709/221

(57) ABSTRACT

The present invention is embodied in a system and method for automatically and dynamically modifying the functionality of the mobile device based on positional data, such as modifying software applications running on the mobile devices. In general, the present invention allows the user of a mobile electronic device to receive information relative to a position, and to have this information modified as the position of the device changes. This is accomplished by automatically and dynamically tracking the electronic device, within a working domain, using a predefined coordinate system. Every portion of the domain is “live”, meaning that each portion can be associated with specific data. Thus, when the electronic device moves from position to position, data relevant to that position is accessed and used to automatically and dynamically modify applications running on the mobile electronic device.

### BACKGROIND OF THE INVENTION

1. Field of the Invention

The present invention relates in general to mobile electronic devices and in particular to a system and method for automatically and dynamically modifying the functionality of the mobile device based on positional data, such as modifying software applications running on the mobile devices.

2. Related Art.

Electronic mobile devices are becoming more and more ubiquitous because they help users manage their busy schedules, as well as communicate with the world. For example, portable computers, such as notebook or laptop computers, personal data assistants (PDAs) and mobile telephones are becoming necessities for many. Notebook or laptop computers are very popular because they are extremely lightweight personal computers that can easily fit in a briefcase for the mobile businessperson. Aside from size, the principal difference between a notebook or laptop computer and a personal computer is the display screen. Portable computers typically use flat-panel technologies, which are lightweight and non-bulky.

A PDA is a handheld mobile device that allows users to access information, keep track of their busy schedules, and communicate with others. A typical PDA can function as a mobile or cellular phone, fax sender, and personal organizer. Recently, many of the major announcements revolve around wireless connectivity for a PDA. It is very important for today's mobile professional to be able to access information from anywhere in the world. Similar to the portable computer, PDAs are very popular because they are designed to be portable and small. Currently, PDA manufactures strive to make PDAs as portable and small as possible. Fitting easily into a wallet, small purse, or shirt pocket, the newest PDAs can travel anywhere in the world. Therefore, people do not think twice about taking their portable computer, PDA or mobile telephone anywhere.

Further, real-time positional systems access coordinate position data from various sources, such as local transmitters or satellites, and are becoming more and more popular. These systems include GPS (Global Position Satellites), MLS (Microwave Landing Systems), GSM (Global System Mobile), GIS (Geographical Information Systems) and CPS (Cambridge Positioning Systems) and have been recently incorporated into personal computers, electronic mobile devices and automobiles. However, limited uses are available for these positioning technologies. For instance, these systems are used to primarily support mobile mapping applications for recreational uses, such as driving directions, camping and hiking.

As such, there are limited business applications available that combine both the portability of these mobile devices with the capabilities of real-time positioning systems. As one example, although mobile electronic devices are small enough to provide portability and convenience in the workplace, current systems lack the power to provide the professional with independent data to work efficiently at a number of varying sites. In typical business environments, access to hard copy records and data can be burdensome and does not cover the range of possibilities that may arise with workplaces that have specific data related to specific locations. Similarly, manual interfacing with a PC is inconvenient and can cause time delays, especially if the database containing the records is relatively large.

Therefore, what is needed is a system and method for automatically and dynamically modifying the functionality of a mobile device based on positional data, such as modifying software applications running on the mobile devices. What is further needed is a system and method that automatically and dynamically locates position, matches data to position and automatically relays modified data to the electronic device for providing an interactive user interface based on the positional data.

### SUMMARY OF THF INVFNTION

To overcome the limitations in the prior art described above, and to overcome other limitations that will become apparent upon reading and understanding the present specification, the present invention is embodied in a system and method for automatically and dynamically modifying the functionality of the mobile device based on positional data, such as modifying software applications running on the mobile devices.

In general, the present invention allows the user of a mobile electronic device to receive information relative to a position, and to have this information modified as the position of the device changes. This is accomplished by automatically and dynamically tracking the electronic device, within a working domain, using a predefined coordinate system. Every portion of the domain is “live”, meaning that each portion can be associated with specific data. Thus, when the electronic device moves from position to position, data relevant to that position is accessed and used to automatically and dynamically modify firmware, software or any suitable module operating on the mobile electronic device.

In particular, the system includes a mobile electronic device having any suitable software running on it and a transmitter system associated within a working domain. First, the system is initiated by the mobile electronic device within the working domain. This allows the mobile electronic device access to positional data, which can be related to the software running on the device. Second, the transmitter system is accessed by the mobile electronic device and specific positional location data of the electronic device is determined. This specific positional data within the working domain is automatically and dynamically provided to the user of the mobile electronic device.

The positional location data is electronically associated with a digital virtual working domain that corresponds with the actual working domain. The software running on the mobile device can be preprogrammed with the digital virtual working domain. Next, the software can associate the positional data with the virtual working domain for proactively changing predefined operations and interfaces based on the actual positional location data. Thus, the user interfaces and the functionality of the mobile device will automatically reflect and specifically relate to the actual location of the user of the device as the user moves in real-time from one location to another.

The present invention as well as a more complete understanding thereof will be made apparent from a study of the following detailed description of the invention in connection with the accompanying drawings and appended claims.

### BRIEF DESCRIPTION OF THF DRAWINGS

Referring now to the drawings in which like reference numbers represent corresponding parts throughout:

FIG. 1 is a general block diagram showing an overview of the present invention.

FIG. 2 is a flow chart illustrating details of the present invention.

FIG. 3 is a diagram illustrating a working example of the present invention in a medical setting.

FIG. 4 is a diagram illustrating a working example of the present invention in a manufacturing setting.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. General Overview of the Components

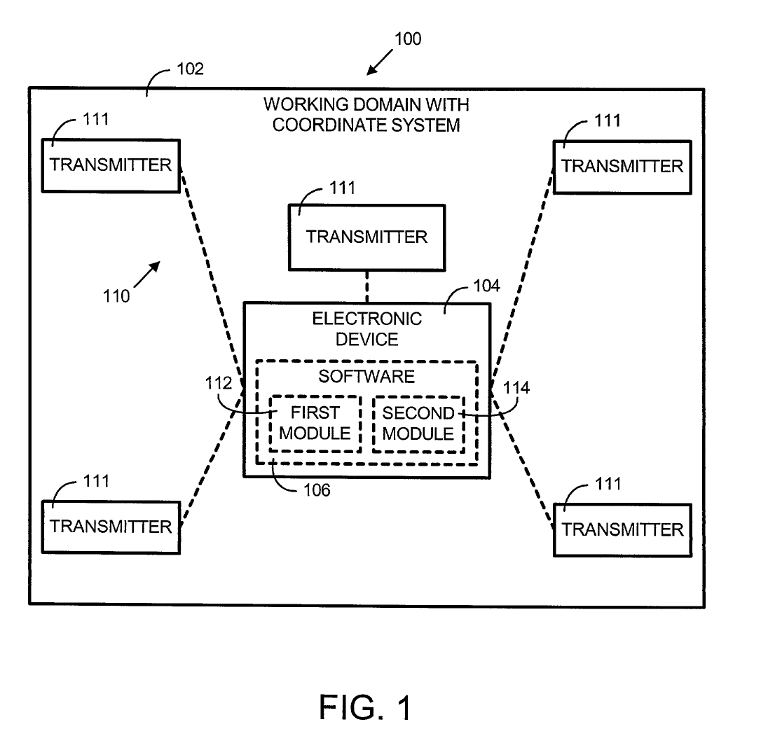

FIG. 1 is a general block diagram showing an overview of the present invention. The system 100 includes a working domain 102 that defines the limits of the system. FIG. 1 depicts the working domain as a two dimensional area for illustrative purposes only, and the working domain can be a three dimensional area, such as a multi-story structure. The working domain can be any predefined area, such as a hospital, a warehouse, a park, or even an entire city, country or continent. Areas within the working domain can be predefined with any suitable three dimensional coordinate system. The system 100 includes a mobile electronic device 104, operational functionality 106 of the mobile device, such as firmware, software or any suitable module operating on the electronic device 104, and a transmitter system 110 that includes plural transmitters 112. The transmitter system 110 can be any suitable positional access system, such as satellite, microwave, infrared, or radio based, which provides positional access, for example triangulation. The number of transmitters 111 in the transmitter system 110 can be determined based on the number required to obtain a clear view for triangulation.

Most types of positional access systems pinpoint location through triangulation. With triangulation, a receiver gathers information from several transmission sources. One type of triangulation is three dimensional (3D) triangulation, which provides latitudinal, longitudinal and elevational coordinates to the receiver. As such, 3D triangulation requires plural transmitters and a predefined coordinate system. For instance, GPS systems typically use 12 satellite transmitters. In the GPS system, a clear view is usually required to allow a receiver to receive a signal from four or more transmitters so that the coordinates of the receiver can be located. Once the coordinates are determined, the specific location can be shown as coordinates or illustrated on an associated electronic map that relates to the actual coordinates.

The mobile electronic device 104 can be any suitable mobile electronic device, such as a notebook, personal data assistant (PDA), cellular/cordless telephone, or similar smaller device. The software 106 is composed of two modules. The first module 112 is a positional access module that is configured to receive data from the transmitter system 110 for accurately locating the position of the mobile electronic device 104 in the working domain 102 and define the data as positional data. A second module 114 is a modification module that is configured to access the positional data and associate the positional data with a virtual working domain for proactively changing predefined operations and interfaces based on the actual positional location data. As a result, the software of the mobile device 104 automatically changes to reflect and specifically relate to the actual location of the user of the device 104 as the user moves in real-time from one location to another within the working domain 102.

Therefore, the present invention allows mobile electronic devices with positional access functions to automatically provide information pertaining to the position in real-time. For instance, a user can be provided with information relating to a specific location automatically and dynamically as the user enters the location, without requiring the user to actively look for the information on their electronic device. As such, user delays and disassociation that can occur as the user moves from location to location can be avoided. This not only prevents delays in providing information, but also reduces confusion of information.

II. Details of the Components and Operation

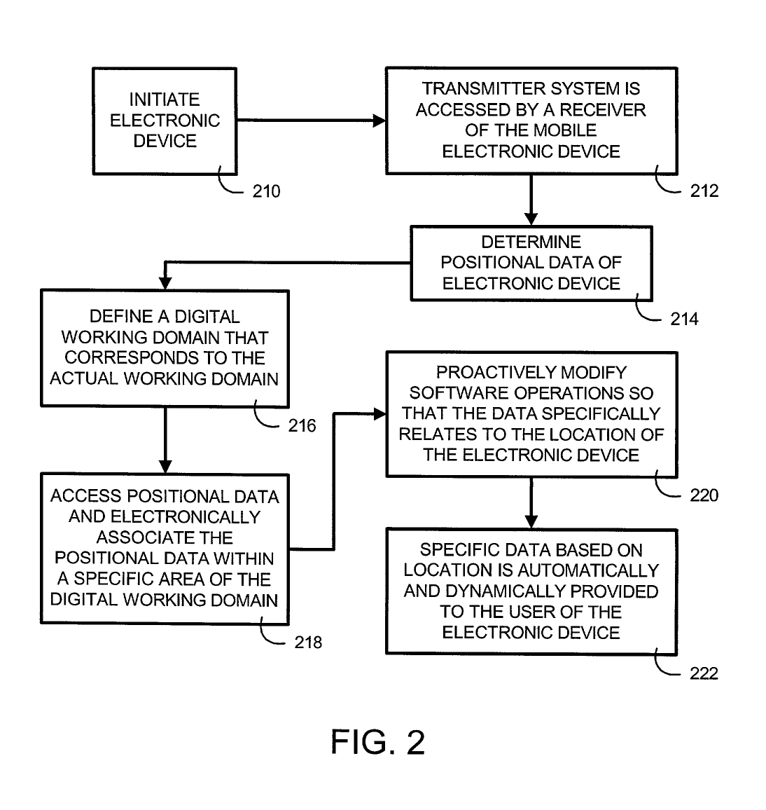

FIG. 2 is a detailed flow chart illustrating a working example of the present invention. Referring to FIG. 2 along with FIG. 1, first, the system 100 is initiated by the mobile electronic device 104 within the working domain 102 (step 210). This allows the mobile electronic device 104 to access positional data, which can be related to the software 106 running on the device 104. Second, the transmitter system 110 is accessed by a receiver of the mobile electronic device 104 (step 212). The receiver of the mobile electronic device 104 determines its location based on coordinates received, for example through triangulation, from the transmitter system (step 214). As such, specific positional location data of the electronic device 104 is determined by the first module 112, namely, latitudinal, longitudinal and elevational coordinates. The specific positional data within the working domain 102 can be automatically and dynamically provided to the user of the mobile electronic device 104 for raw positional data use by the user.

Fourth, a digital virtual working domain can be defined that corresponds to the actual working domain 102 (step 216). The software 106 running on the mobile device 104 can be preprogrammed with the digital virtual working domain. Fifth, the second module 114 accesses the positional location data and electronically associates the positional location data within a specific area of the digital virtual working domain (step 218). Next, the second module 114 proactively changes predefined operations and interfaces of the software 106 based on the actual positional location data (step 220). This allows user interfaces and functional features of the mobile device 104 to automatically reflect and specifically relate to the actual location of the user of the device 104 as the user moves in real-time from one location to another within the working domain 110 (step 222).

III. Working Example

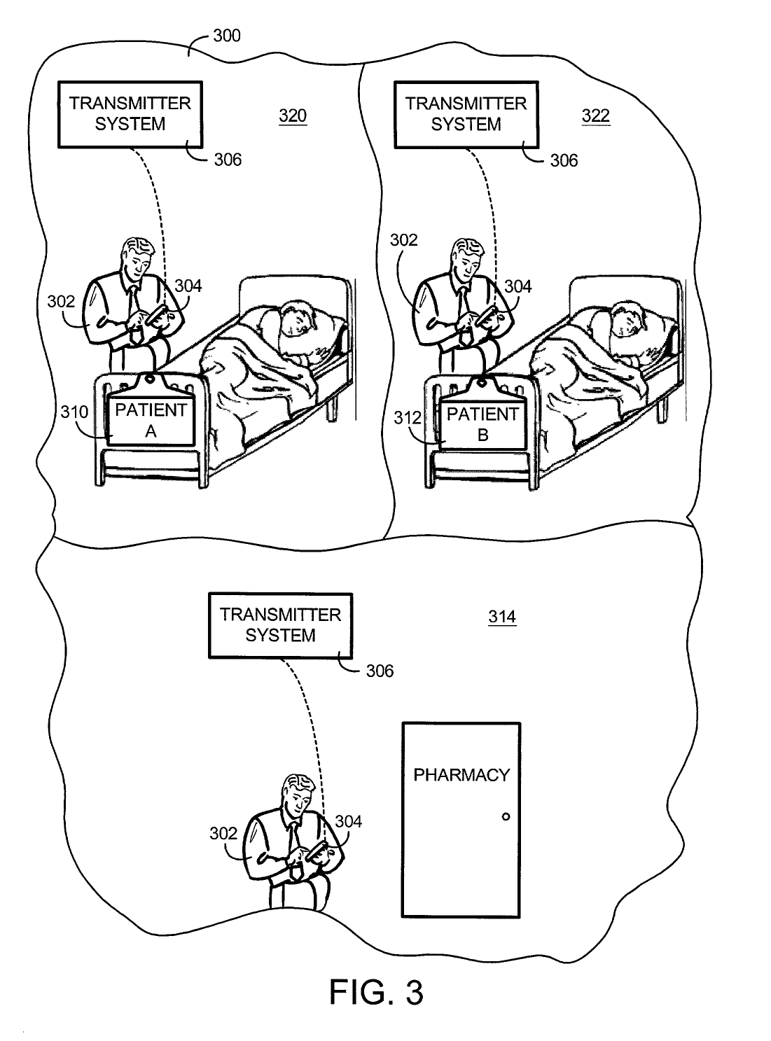

FIG. 3 is a pictorial diagram illustrating the operation of the present invention in the various fields of a particular working domain 300, namely a predefined area of a hospital of medical facility. For instance, typically, hospital workers, such as doctors 302 reference a number of different types of data while performing basic duties, such as medical rounds. Patient records can be accessible through mobile electronic device 304, such as a PDA. The patient records and data can physically reside on the mobile electronic device 304 in local memory, or can be transmitted to the PDA via a wireless network. A transmitter system 306 (similar to the transmitter system 100 of FIG. 1) can be set up throughout the working domain 300.

In general, the PDA 304 can be preprogrammed with the digital virtual working domain representing the predefined area of the hospital or medical facility. The PDA 304 precisely determines its location (latitudinal, longitudinal and elevational data) by analyzing the signals received from plural transmitters of the transmitter system 306 and electronically associates the positional location data within a specific location of the digital virtual working domain. Next, predefined operations and interfaces running on the PDA 304 can proactively change based on the actual positional location data. This allows the doctor to automatically access user interfaces and functional features of the mobile device that specifically relate to the actual location of the user of the device as the doctor moves in real-time from one location to another within the working domain 300.

In this example, based on the analysis of the work performed by the doctor 302 in different locations, the mobile electronic device 304 can take a proactive approach for delivering location specific data. There are several scenarios where this might occur. In one scenario, if a doctor 302 was making rounds and visiting patient A 310 at his/her location 320 and looking at data relating to patient A 310 on the PDA 304, data relating to patient B 312 would be automatically and dynamically provided on the PDA 304 when the doctor 302 moved to patient B's 312 location 322. Further, if the doctor 302 moved to another location, such as a pharmacy location 314, another application associated with the pharmacy could be proactively loaded by the PDA 306 as soon as the doctor entered a location virtually associated with the pharmacy 314 without requiring the doctor 302 to actively look for the information on the PDA. As such, delays and disassociation that can occur as the doctor moves from location to location are avoided.

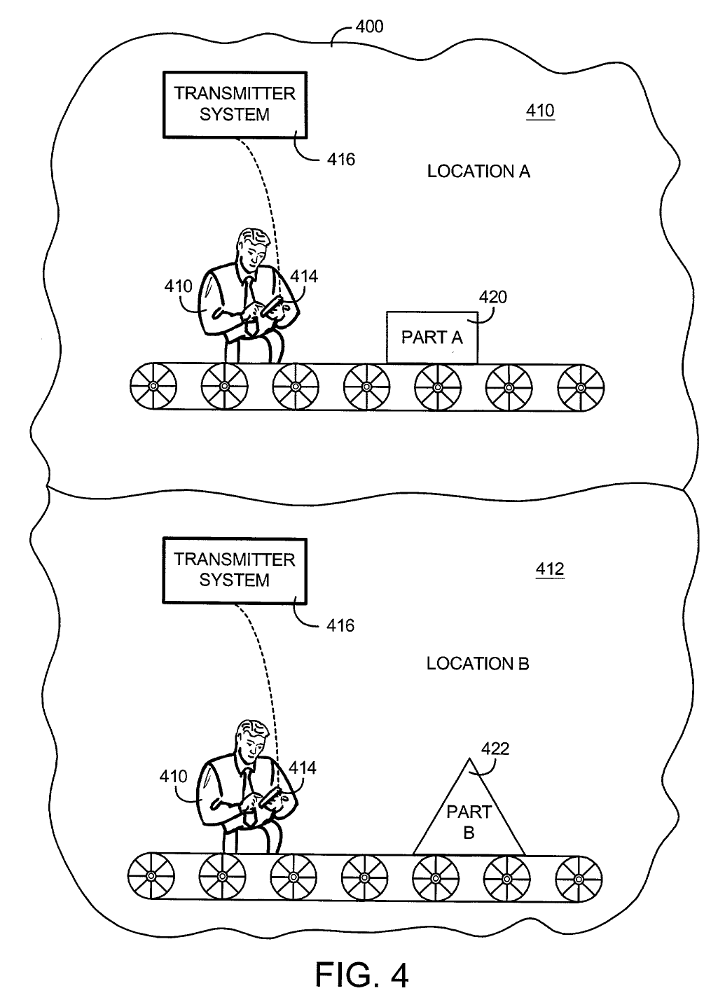

FIG. 4 is another diagram illustrating an example operation of the present invention. In this example, the invention has been set up in the working domain of a manufacturing plant 400. The present invention can be used for numerous applications, for instance in the inspection and maintenance functions in the operation of the manufacturing plant 400. Namely, there are many types of machines and operations used in a manufacturing plant 400, each which are typically located in a different regions or locations. These different regions often need to be inspected for reasons such as qual ity control, efficiency of operation, or replacement of parts.

In one scenario, as an inspector 410 moves from location A 410 (where part A 420 is located) to location B 412 (where part B 422 is located), data specifically relating to each location, such as part A, would dynamically appear on the inspector's PDA 414, for example, showing what would be needed to be examined. The PDA 414 operates in a similar manner as the device 104 discussed above. Specifically, the PDA 414 first locates its position in the plant 400 from transmissions from plant transmitter system 416 (similar to the transmitter system 100 of FIG. 1). Next, the PDA 414 uses the position within the plant 400 to access a virtual plant that has data associated with each predefined location of the plant 400. As such, data related and relevant to a particular location is automatically and dynamically presented to the inspector 410 as the inspector enters predefined locations.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for automatically controlling an electronic device with pertinent data, comprising:
determining an actual location of the electronic device within the working domain; and
using the location of the electronic device to automatically modify functions of the electronic device dynamically as it moves within the working domain.

2. The method of claim 1, further comprising associating locations of the working domain with corresponding locations of a digital virtual domain.

3. The method of claim 2, further comprising electronically associating data related to a location of the digital virtual working domain with a corresponding location of the working domain.

4. The method of claim 1, further comprising changing predefined operations and interfaces of the electronic device based on its actual location.

5. The method of claim 1, wherein the actual location of the electronic device is determined by a global positioning satellite system.

6. The method of claim 1, further comprising using triangulation to determine the actual location of the electronic device within the working domain.

7. The method of claim 6, further comprising using three dimensional triangulation to provide latitudinal, longitudinal and elevational data to the receiver.

8. A system for automatically controlling an electronic device with pertinent data, comprising:
a positioning device that determines an actual location of the electronic device within the working domain; and
a control module that uses the location of the electronic device to automatically modify functions of the electronic device dynamically as it moves within the working domain.

9. The system of claim 8, further comprising a digital virtual domain that has locations associated with corresponding locations of the working domain.

10. The system of claim 8, further comprising a secondary module that electronically associates data related to a location of the digital virtual working domain with a corresponding location of the working domain.

11. The system of claim 8, further comprising a secondary module that changes predefined operations and interfaces of the electronic device based on its actual location.

12. The system of claim 8, wherein the actual location of the electronic device is determined by a global positioning satellite system.

13. The system of claim 8, further comprising plural transmitters that transmit location information to the electronic device and wherein the electronic device includes a receiver to receive coordinate signals from the transmitters.

14. The system of claim 8, wherein the working domain is a medical facility and each location is associated with a unique patient records.

15. The system of claim 14, wherein the functions include loading different patient records.

16. The system of claim 8, wherein triangulation is used to determine the actual location of the electronic device within the working domain.

17. The system of claim 16, further comprising using three dimensional triangulation to provide latitudinal, longitudinal and elevational data to the receiver.

18. A computer-readable medium having computer-executable instructions for performing a process on an electronic device, comprising:
determining an actual location of the electronic device within the working domain;
using the location of the electronic device to automatically modify functions of the electronic device dynamically as it moves within the working domain; and
changing predefined operations and interfaces of the electronic device based on its actual location.

19. The process of claim 18, further comprising associating locations of the working domain with corresponding locations of a digital virtual domain.

20. The process of claim 18, wherein the actual location of the electronic device is determined by a global positioning satellite system that uses three dimensional triangulation to provide latitudinal, longitudinal and elevational data to the receiver.
